(19) United States
(12) Patent Application Publication
(10) Pub. No.: US 2017/0346057 A1
(43) Pub. Date: Nov. 30, 2017

(54) SEPARATOR FOR SECONDARY CELL, METHOD OF MANUFACTURING SEPARATOR FOR SECONDARY CELL, AND SECONDARY CELL

(71) Applicant: Toray Industries, Inc., Tokyo (JP)

(72) Inventors: Nobuyasu Kai, Otsu-shi (JP); Kiyohiko Ito, Otsu-shi (JP)

(21) Appl. No.: 15/533,060

(22) PCT Filed: Dec. 3, 2015
(86) PCT No.: PCT/JP2015/084003

§ 371 Date: Jun. 5, 2017

(30) Foreign Application Priority Data
Dec. 9, 2014 (JP) 2014-248591
Sep. 3, 2015 (JP) 2015-173514

(51) Int. Cl. H01M 2/16; H01M 2/14; H01M 10/02; H01M 10/10

(52) U.S. Cl. CPC H01M 2/16; H01M 10/10; H01M 2/145; H01M 10/02

(57) ABSTRACT

A secondary battery separator includes a porous substrate; and a porous layer laminated on at least one surface of the porous substrate, the porous layer comprising fluorine resin particles and inorganic particles; wherein the fluorine resin particles are formed using a fluorine resin having a weight-average molecular weight of 100,000 or more and 5,000,000 or less, and have an average particle size of 0.01 μm or more and 1.00 μm or less; and wherein the inorganic particles have an average particle size of 0.10 μm or more and 5.0 μm or less.

### TECHNICAL FIELD

This disclosure relates to a secondary battery separator, a method of producing a secondary battery separator, and a secondary battery.

### BACKGROUND

Secondary batteries such as lithium ion batteries have been widely used in portable digital equipment such as mobile phones, notebook personal computers, digital cameras, digital video cameras, and portable game consoles. In recent years, secondary batteries are increasingly used in automobile applications, for example, as power supplies for hybrid vehicles, electric cars, plug-in hybrid vehicles and the like.

A lithium ion battery generally has a structure including: a positive electrode including a positive electrode current collector and a positive active material laminated on the positive electrode current collector; a negative electrode including a negative electrode current collector and a negative active material laminated on the negative electrode current collector; and a secondary battery separator and an electrolyte interposed between the positive electrode and the negative electrode.

Polyolefin porous substrates have been used as secondary battery separators. Properties required for a secondary battery separator include: a property to contain an electrolyte solution in its porous structure, and to allow migration of ions therein; and a property to melt due to heat, when a lithium ion battery is overheated so that the porous structure is blocked to inhibit migration of ions, thereby stopping generation of power.

However, with an increase in capacity and power of lithium ion batteries in recent years, an adhesive property to an electrode is now required for a secondary battery separator in addition to the above described properties to prevent the generation of gaps between the electrode and the secondary battery separator due to repeated charging and discharging, and thereby preventing the deterioration of cycle performance. Further, with an increase in capacity and power of lithium ion batteries in recent years, a higher safety and, accordingly, a higher dimensional stability are also required for a secondary battery separator to prevent short circuit fault due to contact between the positive electrode and the negative electrode, which occurs as a result of heat shrinkage of the secondary battery separator at a high temperature. Still further, with a growing popularity of secondary batteries, a reduction in the production cost is demanded, and there is also a need for a secondary battery separator which is available at a low cost.

In view of these needs, JP 2004-146190 A and JP 2012-221741 A propose secondary battery separators in which the adhesive property to an electrode is improved, by laminating a porous layer comprising, as a main component, a polyvinylidene fluoride resin having an adhesive property, on a porous substrate composed of a polyolefin. JP 5355823 B proposes a secondary battery separator in which the adhesive property to an electrode is improved, by laminating a porous layer comprising, as a main component, particles composed of a polyvinylidene fluoride resin having an adhesive property, on a porous substrate composed of a polyolefin. Further, WO 2013/133074 proposes a secondary battery separator in which the adhesive property to an electrode and the dimensional stability are improved, by laminating a porous layer including: particles composed of a polyvinylidene fluoride resin having an adhesive property; and inorganic particles; on a porous substrate composed of a polyolefin.

However, the secondary battery separators proposed in JP '190 and JP '741 are produced by a method in which a fluorine resin is dissolved in an organic solvent, and the resulting resin solution is coated on a mold release film or a porous substrate, followed by immersing the resultant in a coagulation bath, thereby forming a porous layer. Although that production method improves the adhesive property to an electrode, it is an expensive method, and thus unable to satisfy the current need for low cost production. Further, the secondary battery separators proposed in JP '823 and WO '074 have a poor adhesive property due to using a polyvinylidene fluoride resin having an inadequate molecular weight, and a sufficient adhesive property to an electrode cannot be obtained.

Accordingly, it could be helpful to provide a secondary battery separator having an adhesive property to an electrode and dimensional stability, at a low cost.

### SUMMARY

We discovered that the use of a fluorine resin having a molecular weight within a specific range imparts an adhesive property to an electrode, and to the resulting secondary battery separator. Further, we made it possible to provide a secondary battery separator having an adhesive property to an electrode and dimensional stability, at a low cost, by forming particles of the fluorine resin; preparing a coating agent by mixing the fluorine resin particles with inorganic particles; and coating the coating agent by a general coating method.

We thus provide:

(1) A secondary battery separator comprising:

a porous substrate; and

a porous layer laminated on at least one surface of the porous substrate, the porous layer comprising fluorine resin particles and inorganic particles;

wherein the fluorine resin particles are formed using a fluorine resin having a weight-average molecular weight of 100,000 or more and 5,000,000 or less, and have an average particle size of 0.01 μm or more and 1.00 μm or less; and

wherein the inorganic particles have an average particle size of 0.10 μm or more and 5.0 μm or less.
(2) A secondary battery separator comprising:

a porous substrate; and

a porous layer laminated on at least one surface of the porous substrate, the porous layer comprising fluorine resin particles and inorganic particles;

wherein the fluorine resin particles are formed using a fluorine resin having a weight-average molecular weight of 600,000 or more and 1,500,000 or less, and have an average particle size of 0.02 μm or more and 0.40 μm or less; and

wherein the inorganic particles have an average particle size of 0.10 μm or more and 5.0 μm or less.
(3) The secondary battery separator according to (1) or (2), wherein the inorganic particles have an average particle size of not less than 0.2 times and not more than 100 times the average particle size of the fluorine resin particles.
(4) The secondary battery separator according to any one of (1) to (3), wherein the fluorine resin is a polyvinylidene fluoride resin, and wherein the polyvinylidene fluoride resin has a vinylidene fluoride content of 80 mol % or more and less than 100 mol %.
(5) The secondary battery separator according to any one of (1) to (4), wherein the fluorine resin includes an acid functional group.
(6) The secondary battery separator according to (5), wherein the acid functional group is a carboxylic acid group.
(7) The secondary battery separator according to any one of (1) to (6), wherein the fluorine resin particles are included in the porous layer in a proportion of 10% by mass or more and 90% by mass or less with respect to 100% by mass of the total amount of the porous layer.
(8) The secondary battery separator according to any one of (1) to (7), wherein the porous layer per one surface has a thickness 0.1 μm or more 5.0 μm or less.
(9) The secondary battery separator according to any one of (1) to (8), wherein the porous substrate is a polyolefin porous substrate.
(10) The secondary battery separator according to any one of (1) to (9), wherein the porous layer comprises an organic resin binder in an amount of 1.0 part by mass or more and 100 parts by mass or less with respect to 100 parts by mass of the total amount of the fluorine resin particles and the inorganic particles.
(11) A method of producing a secondary battery separator, the method comprising the steps of:

dispersing fluorine resin particles and inorganic particles in a solvent comprising water as a main component to obtain a dispersion liquid, wherein the fluorine resin particles are formed using a fluorine resin having a weight-average molecular weight of 100,000 or more and 5,000,000 or less, and have an average particle size of 0.01 μm or more and 1.00 μm or less; and wherein the inorganic particles have an average particle size of 0.10 μm or more and 5.0 μm or less;

coating the resulting dispersion liquid on at least one surface of a porous substrate; and

then drying the resultant to laminate a porous layer comprising the fluorine resin particles and the inorganic particles on the porous substrate.
(12) The method of producing a secondary battery separator according to (11), wherein the fluorine resin particles are obtained by adding a fluorine resin solution prepared by dissolving a fluorine resin in a solvent and water to a poor solvent, to allow precipitation of the fluorine resin particles;

wherein the amount of water is 1% by mass or more and 25% by mass or less with respect to 100% by mass of the total amount of the solvent and water; and

wherein the amount of the fluorine resin is 0.1% by mass or more and 15% by mass or less with respect to 100% by mass of the total amount of the solvent and water.
(13) A secondary battery comprising the secondary battery separator according to any one of (1) to (10), or a secondary battery separator obtained by the method of producing a secondary battery separator according to (11) or (12).

We impart to the secondary battery separator, a sufficient adhesive property to an electrode by using specific fluorine resin particles, and dimensional stability by including inorganic particles in the porous layer. The use of the secondary battery separator provides a lithium ion battery having a high capacity, a high power and a long service life, at a low cost.

### DETAILED DESCRIPTION

The secondary battery separator comprises: a porous substrate; and a porous layer laminated on at least one surface of the porous substrate, the porous layer comprising fluorine resin particles and inorganic particles; wherein the fluorine resin particles are formed using a fluorine resin having a weight-average molecular weight of 100,000 or more and 5,000,000 or less, and have an average particle size of 0.01 μm or more and 1.00 μm or less; and wherein the inorganic particles have an average particle size of 0.10 μm or more and 5.0 μm or less.

### Porous Layer

### Fluorine Resin Particles

Examples of the fluorine resin used to form the fluorine resin particles included in the porous layer include: homopolymers such as polyvinylidene fluorides, polytetrafluoroethylenes, polyvinyl fluorides, and polychlorotrifluoroethylenes; and copolymers such as ethylene-tetrafluoroethylene polymers, and ethylene-chlorotrifluoroethylene polymers. Examples thereof also include a copolymer of the homopolymer and tetrafluoroethylene, hexafluoropropylene or trifluoroethylene. Among these fluorine resins, a polyvinylidene fluoride resin, particularly, a resin composed of a copolymer of vinylidene fluoride and hexafluoropropylene is preferably used, in terms of electrical stability and oxidation resistance.

Further, the polyvinylidene fluoride resin preferably has a vinylidene fluoride content of 80 mol % or more and less than 100 mol %. The vinylidene fluoride content is more preferably 85 mol % or more and 99 mol % or less. The vinylidene fluoride content is still more preferably 90 mol % or more and 98 mol % or less. A vinylidene fluoride content of less than 80 mol % may result in a failure to provide sufficient mechanical strength. A vinylidene fluoride content of 100 mol %, on the other hand, reduces the swellability of the porous layer in an electrolyte solution, possibly resulting in a failure to provide sufficient adhesive property.

The above described fluorine resin has a weight-average molecular weight of 100,000 or more and 5,000,000 or less. The weight-average molecular weight is preferably 300,000 or more and 3,000,000 or less. The weight-average molecular weight is more preferably 600,000 or more and 1,500,000 or less. The weight-average molecular weight is still more preferably 800,000 or more and 1,200,000 or less. When the fluorine resin has a weight-average molecular weight of less than 100,000, the resulting porous layer may be, while having an adhesive property to an electrode, susceptible to peeling due to insufficient strength of the adhesive property. When the fluorine resin has a weight-average molecular weight of greater than 5,000,000, on the other hand, the swellability in an electrolyte solution may be reduced, thereby decreasing the adhesive property.

The fluorine resin particles are formed using a fluorine resin having a weight-average molecular weight of 100,000 or more and 5,000,000 or less. The fluorine resin particles may include a resin other than the fluorine resin such as an acrylic resin. When our fluorine resin and another resin other than our fluorine resin are mixed uniformly, the proportion of our fluorine resin is preferably 50% by mass or more, and more preferably 70% by mass or more, with respect to 100% by mass of the total mass of the fluorine resin particles. However, when the fluorine resin particles are core-shell type particles composed of a core made of the resin other than our fluorine resin, and a shell made of our fluorine resin, for example, the proportion of our fluorine resin may be less than 50% by mass with respect to 100% by mass of the total mass of the fluorine resin particles.

Further, our fluorine resin may include a plurality of types of fluorine resins as a mixture. When a plurality of types of fluorine resins are mixed uniformly, the weight-average molecular weight of the plurality of types of the fluorine resins is 100,000 or more and 5,000,000 or less. However, when the fluorine resin particles are core-shell type particles composed of a shell made of our fluorine resin, and a core made of other fluorine resins, for example, the weight-average molecular weight of the other fluorine resins need not be 100,000 or more and 5,000,000 or less.

The fluorine resin preferably includes an acid functional group to improve the adhesive property to an electrode. The acid functional group is a functional group capable of releasing a proton (H). Specific examples of the acid functional group include carboxylic acid group, sulfonic acid group, phosphate group, hydroxyl group, and phenolic hydroxyl group. These groups may be used singly, or in combination of two or more kinds thereof

Particularly preferred as the acid functional group is carboxylic acid group, and examples of monomers containing a carboxylic acid group include: monocarboxylic acids such as acrylic acid, methacrylic acid and crotonic acid, and derivatives thereof; and dicarboxylic acids such as maleic acid, fumaric acid, itaconic acid, and citraconic acid, acid anhydrides thereof and derivatives thereof. These compounds may be used singly, or in combination of two or more kinds thereof. Of these, a dicarboxylic acid is preferred, and maleic acid is particularly preferred.

The fluorine resin particles have an average particle size of 0.01 μm or more and 1.00 μm or less. The average particle size is preferably 0.02 μm or more and 0.40 μm or less. The average particle size is more preferably 0.03 μm or more and 0.35 μm or less. The average particle size is still more preferably 0.06 μm or more and 0.20 μm or less. When the fluorine resin particles have an average particle size of less than 0.01 μm, the fluorine resin particles may be densely laminated, resulting in a greater increase in air permeability. When the fluorine resin particles have an average particle size of greater than 1.00 μm, on the other hand, the contact area between the fluorine resin particles and the electrode may be reduced, resulting in a failure to provide sufficient adhesive property. Further, since the distance between the inorganic particles is increased, the dimensional stability may also be decreased.

Note that the average particle size as used herein refers, as will be described in the Examples, to a value obtained by measuring the length of one side of a square or the long side (long axis diameter) of a rectangle which entirely surrounds a fluorine resin particle of the surface of the porous layer observed by a microscope, and by calculating the number average of the length. The details of the measurement method will be described later.

The fluorine resin particles may have any shape, and may be in the shape of, for example, a sphere, a plate, a needle, a rod, an oval, or the like. Of these, particularly preferred are the fluorine resin particles in the shape of a sphere or a plate, in terms of dispersibility, coating performance, and porosifying effect.

The fluorine resin particles preferably have an aspect ratio of 100 or less, more preferably 50 or less, and still more preferably 30 or less. When the fluorine resin particles have an aspect ratio of greater than 100, the handleability of the fluorine resin particles may be reduced.

Note that the aspect ratio as used herein refers, as will be described in Examples, to a value obtained by drawing a square or a rectangle which entirely surrounds a fluorine resin particle on an image of the particles obtained by an electron microscope, and by dividing the measured value of the length of the long side (long axis diameter) of the rectangle by the measured value of the length of the short side (short axis diameter). When the rectangle surrounding the particle is a square, the particle has an aspect ratio of 1.

The fluorine resin particles can be produced by a known method such as emulsion polymerization, suspension polymerization, or dispersion polymerization. The fluorine resin particles produced by any one of the above mentioned methods may be subjected to further processing to obtain fluorine resin particles having a desired average particle size and a desired shape. Examples thereof include a coagulation method, a phase separation method, a dry grinding method, a wet grinding method, a spray dryer method and the like.

Examples of the coagulation method include a method in which a fluorine resin is dissolved in a solvent, or in a solvent and water, to obtain a fluorine resin solution, and the thus obtained fluorine resin solution is added to a poor solvent, to allow precipitation of the fluorine resin particles.

The solvent to be used to dissolve the fluorine resin may be, for example, any solvent capable of dissolving the fluorine resin and which mixes well with water.

Specific examples of the solvent include N-alkylpyrrolidone solvents such as N-methyl-2-pyrrolidone (hereinafter, sometimes abbreviated as NMP); urea solvents such as 1,3-dimethyl-2-imidazolidinone (hereinafter, sometimes abbreviated as DMI); linear amide solvents such as N,N-dimethylacetamide (hereinafter, sometimes abbreviated as DMAc) and N,N-dimethylformamide (hereinafter, sometimes abbreviated as DMF); sulfur oxide polar solvents such as dimethyl sulfoxide (hereinafter, sometimes abbreviated as DMSO), dimethyl sulfone, and tetramethylene sulfone; ketone solvents such as acetone and methyl ethyl ketone; and nitrile solvents such as acetonitrile and propionitrile. Of these, preferred are NMP, DMI, acetone, methyl ethyl ketone and acetonitrile, and more preferred are NMP and acetonitrile, in terms of solvent stability and ease of handling.

It is preferred that a dissolution tank be placed in an atmosphere having a low oxygen gas concentration to inhibit decomposition and deterioration of the fluorine resin and, further, to secure the safety in the production process. Accordingly, the dissolution tank is preferably placed in an inert gas atmosphere. Examples of the inert gas include nitrogen gas, carbon dioxide gas, helium gas, argon gas, and the like. Of these, nitrogen gas, argon gas, or carbon dioxide gas is preferred, in terms of economic efficiency and ease of availability. Nitrogen gas or argon gas is particularly preferably used.

The method of dissolving the fluorine resin is not particularly limited. In preparing a fluorine resin solution, a fluorine resin, a solvent and water are placed in a specified container, and the resin is allowed dissolve while stirring. When the resin does not dissolve at normal temperature, the resin is dissolved by applying heat.

It is also possible to add water after dissolving the fluorine resin in a solvent. In a method in which water is added after dissolving the fluorine resin, a fluorine resin solution is prepared in a specified container, and then water is added to the fluorine resin solution. A liquid transfer pump, a Komagome pipette, or the like can be used for the addition of water. It is preferred that water be added gradually, because the addition of a large amount of water at a time results in the precipitation of the fluorine resin, thereby requiring a longer time to dissolve the fluorine resin. To produce fluorine resin particles having a uniform particle size, it is preferred that the fluorine resin be completely dissolved in a solvent, before adding the resulting resin solution to a poor solvent, or that the fluorine resin particles be allowed to precipitate by flash crystallization. However, undissolved fluorine resin may be present in the resulting resin solution.

The amount of water to be added varies depending on the concentration of the fluorine resin to be dissolved, and the type of the solvent used. The amount of water to be added is preferably 1% by mass or more and 25% by mass or less, with respect to 100% by mass of the total amount of the solvent and water added. Too small an amount of water added may lead to the generation of deformed particles, while too large an amount of water added may result in precipitation of the fluorine resin.

The temperature for dissolving the fluorine resin varies depending on the type of the solvent used and the concentration of the fluorine resin. The dissolving temperature is usually from normal temperature to 200° C., preferably from normal temperature to 100° C., or not more than the boiling point of the solvent.

The duration of time to dissolve the fluorine resin varies depending on the type of the solvent, the concentration of the resin, and the dissolving temperature. The dissolving time is usually 5 minutes to 50 hours, and preferably 10 minutes to 40 hours.

Too high a concentration of the fluorine resin may lead to the occurrence of fusion bonding between the fluorine resin particles, when the fluorine resin solution is added to a poor solvent to allow precipitation of the fluorine resin particles. This may result in a failure to obtain fluorine resin particles having a small particle size, or fluorine resin particles having a uniform particle size.

Accordingly, it is preferred that the amount of the fluorine resin in the fluorine resin solution be 0.1% by mass or more and 15% by mass or less, with respect to 100% by mass of the solvent in the case of including no water, and with respect to 100% by mass of the total amount of the solvent and water in the case of including water. The amount of the fluorine resin is more preferably 0.5% by mass or more and 10% by mass or less.

A description regarding the poor solvent will be given in detail later.

When the amount of the fluorine resin is 0.1% by mass or more and 15% by mass or less with respect to 100% by mass of the total amount of the solvent and water, the applicability to industrial production is increased, and therefore preferred. After dissolving the fluorine resin in the solvent, or in the solvent and water, the resulting fluorine resin solution may be subjected to a precipitation step.

Examples of the precipitation step include the following (step a1), particularly, the (step a2):
(Step a1): A step of adding the fluorine resin solution to a poor solvent to allow precipitation of the fluorine resin particles.
(Step a2): A step of adding the fluorine resin solution to a poor solvent to allow precipitation of the fluorine resin particles by flash crystallization.

In the (step al), the fluorine resin solution is added to a poor solvent for the fluorine resin to allow precipitation of the fluorine resin particles.

When adding the fluorine resin solution to a poor solvent for the fluorine resin, the resin solution may be injected or dropped continuously from a container containing the fluorine resin solution, into a container (hereinafter, sometimes referred to as a “receiving tank”) containing the poor solvent for the fluorine resin. Further, the fluorine resin solution may be added from above the poor solvent via a gas phase. It is preferred that the poor solvent be added directly to the fluorine resin solution, because it obtains fine particles having a uniform particle size.

There are two methods of producing the fluorine resin particles by bringing the fluorine resin and a poor solvent into contact. One is a method in which the fluorine resin solution is added to a receiving tank containing the poor solvent to prepare a particle-forming liquid, and the then the resulting particle-forming liquid is extracted to be subjected to a subsequent step (batch method); and another is a continuous flow method (sometimes simply referred to as a continuous method). There are two types of reactors to be used in the continuous flow method: a continuous stirred tank reactor (abbreviated as CSTR); and a plug flow reactor (abbreviated as PFR). Either of the reactors can be used to produce the particles of the fluorine resin.

The method utilizing a CSTR is a method in which: a poor solvent is introduced into a receiving tank (sometimes referred to as a reactor in the continuous method); the fluorine resin solution is added thereto to produce fluorine resin particles; and then the resulting particle-forming liquid of the fluorine resin is continuously extracted from the receiving tank, while adding to the particle-forming liquid the fluorine resin solution and the poor solvent simultaneously by dropping, thereby producing the particles continuously. Alternatively, a particle-forming liquid of the fluorine resin may be prepared by a batch method, and the resulting particle-forming liquid of the fluorine resin may be continuously extracted from the receiving tank, while adding thereto the fluorine resin solution and the poor solvent simultaneously by dropping, thereby preparing the particle-forming liquid.

In utilizing a CSTR, it is preferred that the fluorine resin solution and the poor solvent be added simultaneously by dropping. The ratio of the dropping speed of the poor solvent to the dropping speed of the fluorine resin solution is not particularly limited, as long as the fluorine resin particles can be formed. However, the ratio of the dropping speed of the poor solvent to the dropping speed of the fluorine resin solution is preferably 0.1 to 100, and more preferably 0.2 to 50, in terms of productivity.

The ratio of the mass of the particle-forming liquid in the receiving tank (reactor) to the extraction flow rate of the particle-forming liquid from the receiving tank is taken as the residence time. The residence time is not particularly limited, as long as fine particles having a uniform particle size can be obtained. However, the residence time is preferably 1 second to 10 hours, and more preferably 1 minute to 1 hour.

A mixing apparatus may be installed to the receiving tank, for the purpose of maintaining the homogeneity of the particle-forming liquid. Examples of the mixing apparatus include a stirring blade, a twin-screw mixer, a homogenizer, an ultrasonic irradiation apparatus and the like.

The method utilizing a PFR is a method in which: the fluorine resin solution and a poor solvent are introduced into a piping to flow therethrough at a constant rate; the fluorine resin solution and the poor solvent are mixed in the piping to produce particles; and the resulting particle-forming liquid is extracted continuously. Various types of pipes can be used for the method. When two pipings are used, for example, it is possible to introduce the fluorine resin solution into an inner pipe, and the poor solvent into an outer pipe, to flow therethrough at a constant rate, and to mix the fluorine resin solution and the poor solvent in the outer pipe, thereby producing the particles. Alternatively, the fluorine resin solution may be introduced into the outer pipe, and the poor solvent may be introduced into the inner pipe, to flow therethrough.

When one piping is used to continuously produce particles, for example, in the case of using a T-shaped piping, the poor solvent can be introduced from the direction 90 degrees to the direction of the flow of the fluorine resin solution, to bring the fluorine resin solution and the poor solvent into contact, thereby producing the particles.

Since various types of pipings can be used to mix the fluorine resin solution and the poor solvent, to continuously produce fluorine resin particles, the method utilizing a PFR is not limited to those described above.

In utilizing a PFR, the fluid flow speed of the fluorine resin solution and the fluid flow speed of the poor solvent are not particularly limited, as long as the fluorine resin particles can be produced. In terms of productivity, the ratio of the fluid flow speed of the fluorine resin solution to the fluid flow speed of the poor solvent is preferably 0.1 to 100, and more preferably 0.2 to 50.

Further, mixing the fluorine resin solution and the poor solvent may be carried out entirely in the piping, or alternatively, a tubular mixing apparatus may be provided for the mixing. Examples of the tubular mixing apparatus include a tubular mixing apparatus including any of the above mentioned mixing apparatuses or a static mixing structure such as a static mixer.

The duration of time to mix the fluorine resin solution and the poor solvent may be within the same range as described for the residence time. The inner diameter of the piping is not particularly limited, as long as the fluorine resin solution and the poor solvent can be mixed. The inner diameter is preferably 0.1 mm to 1 m, and more preferably 1 mm to 1 m, in terms of productivity.

When two pipings are used as an inner pipe and an outer pipe, the ratio of the diameter of the inner pipe to the diameter of the outer pipe is not particularly limited, as long as it allows for preparing a particle-forming liquid. The ratio of the inner pipe diameter to the outer pipe diameter: outer pipe diameter/inner pipe diameter is preferably 1.1 to 500, and more preferably 1.1 to 100.

Examples of the poor solvent for the fluorine resin particles include: aliphatic hydrocarbon solvents such as pentane, hexane, heptane, octane, nonane, and decane; aromatic hydrocarbon solvents such as benzene, toluene, o-xylene, m-xylene, p-xylene, and naphthalene; ester solvents such as ethyl acetate, methyl acetate, butyl acetate, and butyl propionate; ether solvents such as diethyl ether, diisopropyl ether, tetrahydrofuran, and dioxane; alcohol solvents such as methanol, ethanol, 1-propanol, and 2-propanol; water; and the like.

Of these, alcohol solvents such as methanol, ethanol, 1-propanol and 2-propanol, and water are preferred. Particularly preferred are methanol, ethanol and water.

The poor solvent for the fluorine resin is preferably a solvent that can be mixed uniformly with the solvent used to dissolve the fluorine resin, in terms of allowing the fluorine resin particles to be uniformly dispersed in the poor solvent. The phrase “mixed uniformly” as used above means that, when two or more solvents are mixed and left to stand for one day, no interface is formed in the mixture. Examples of solvents which can be mixed uniformly with water include NMP, DMF, DMAc, acetone, DMSO, tetrahydrofuran, acetonitrile, methanol, ethanol and the like.

Further, the poor solvent for the fluorine resin may be used singly, or two or more may be used as a mixture as long as the poor solvent or the solvents can be mixed uniformly with the solvent used for dissolving the fluorine resin. In particular, a solvent containing water such as a mixed solvent of water and an alcohol solvent, or a mixed solvent of water and a nitrile solvent is preferably used, because fine particles having a uniform particle size are more likely to be obtained.

The amount to be used of the poor solvent for the fluorine resin is not particularly limited, and it may be, for example, 0.1 parts by mass or more and 100 parts by mass or less with respect to 1 part by mass of the amount of the solvent used for dissolving the fluorine resin. The amount to be used of the poor solvent is preferably 0.1 parts by mass or more and 50 parts by mass or less, and more preferably 0.1 parts by mass or more and 10 parts by mass or less.

The temperature of the receiving tank in adding the fluorine resin solution to the poor solvent for the fluorine resin can be set within the range of not less than 0° C. and not more than the boiling point of the poor solvent. The temperature of the receiving tank immediately before the addition is preferably not less than 0° C. and not more than 40° C., because there are cases where fusion bonding between the particles may occur depending on the type of the solvent used, possibly resulting in a failure to produce particles. By adding the fluorine resin solution to the poor solvent, the fluorine resin particles are precipitated from the fluorine resin solution, and a liquid in which the fluorine resin particles are dispersed or suspended can be obtained. It is preferred to stir the poor solvent for the fluorine resin, when adding the fluorine resin solution to the poor solvent.

In the (step a2), the fluorine resin solution in which the fluorine resin is dissolved is subjected to flash crystallization to allow fluorine resin particles to precipitate. In other words, it is a step in which flash crystallization is utilized, in the method of adding the fluorine resin solution to the poor solvent.

The flash crystallization refers to a method in which the fluorine resin solution is allowed to rapidly solidify and crystallize. More specifically, the flash crystallization is a method in which the fluorine resin solution under heating and pressure is ejected in a jet through a nozzle to be transferred into another container (hereinafter, sometimes referred to as a receiving tank) which is maintained at a temperature less than the boiling point at normal pressure of the solvent used for dissolving the fluorine resin (or a temperature not more than the normal temperature) and at a pressure less than the pressure applied to the fluorine resin solution (or under reduced pressure), thereby allowing crystallization to occur. Alternatively, the flash crystallization is a method in which the fluorine resin solution under pressure is ejected in a jet through a nozzle to be transferred into another container (hereinafter, sometimes referred to as a receiving tank) maintained at a pressure less than the pressure applied to the fluorine resin (or under reduced pressure), thereby allowing crystallization to occur.

When carrying out flash crystallization, it is preferred that the fluorine resin solution be ejected directly into the poor solvent. The flash crystallization is preferably carried out in a state where the tip of the nozzle through which the fluorine resin solution is ejected is disposed submerged in the poor solvent inside the receiving tank. Alternatively, the tip of the nozzle may be disposed above and away from the surface of the poor solvent so that the flash crystallization is carried out by ejecting the fluorine resin solution via a gas phase from above the poor solvent.

Specific details will be given below. It is preferred that the flash crystallization be carried out by allowing the fluorine resin solution in a container under heating and pressure, or under pressure, to be ejected in a jet into a receiving tank under atmospheric pressure (or under reduced pressure). When the fluorine resin is heated and dissolved in a pressure-resistant container such as an autoclave in the step of dissolving the resin, for example, the interior of the container becomes pressurized as a result of self-generated pressure due to heating (a further pressure may be applied by an inert gas such as nitrogen gas). By discharging the fluorine resin solution in this pressurized state into the receiving tank under atmospheric pressure to release the pressure, the flash crystallization can be carried out even more easily. When the fluorine resin is dissolved at normal temperature, the fluorine resin particles can be obtained by pressurizing the dissolution tank to an arbitrary pressure, and then ejecting the pressurized fluorine resin solution into the poor solvent for the fluorine resin, to allow flash crystallization to occur.

There is no particular limitation on the poor solvent to be used in carrying out the flash crystallization by ejecting the fluorine resin solution into the poor solvent, and the same poor solvents as those described in the section of the (step al) can be used.

The amount to be used of the poor solvent for the fluorine resin is not particularly limited, and it may be, for example, 0.1 parts by mass or more and 100 parts by mass or less with respect to 1 part by mass of the solvent used for dissolving the fluorine resin. The amount of the poor solvent is preferably 0.1 parts by mass or more and 50 parts by mass or less. The amount of the poor solvent is more preferably 0.1 parts by mass or more and 10 parts by mass or less.

When carrying out the flash crystallization, it is possible to use: a method in which the flash crystallization is carried out in a single stage, by ejecting a fluorine resin solution prepared by dissolving the resin at a temperature of usually from normal temperature to 200° C., and preferably from normal temperature to 100° C., into a container maintained at a pressure less than the pressure range to be describe later, or at a reduced pressure; or a method in which the flash crystallization is carried out in multiple stages, by ejecting the fluorine resin solution into a container maintained at a pressure lower than the pressure applied to the tank containing the resin solution. Specifically, when the fluorine resin is heated and dissolved in a pressure-resistant container such as an autoclave in the step of dissolving the resin, for example, the interior of the container becomes pressurized as a result of self-generated pressure due to heating (a pressure increase due to heating) (a further pressure may be applied by an inert gas such as nitrogen gas). The resin solution in this pressurized state is ejected either into a receiving tank containing the poor solvent for the fluorine resin and maintained under atmospheric pressure, or into a receiving tank maintained under reduced pressure, to allow flash crystallization to occur. Further, when the fluorine resin is dissolved without heating in a pressure-resistant container such as an autoclave, an arbitrary pressure is applied to the resulting resin solution, and the thus pressurized resin solution is ejected either into a receiving tank containing the poor solvent for the fluorine resin and maintained under atmospheric pressure, or into a receiving tank maintained under reduced pressure, to allow flash crystallization to occur. The pressure (gauge pressure) applied to the resin solution for carrying out the flash crystallization is preferably 0.2 MPa or more and 4MPa or less. It is preferred that the resin solution under this condition be ejected into a receiving tank under atmospheric pressure to allow flash crystallization to occur.

The temperature of the receiving tank varies depending on the type of the poor solvent for the fluorine resin to be introduced into the receiving tank. The temperature is preferably above the solidification temperature of the poor solvent for the fluorine resin and up to 50° C. Specifically, in water, the temperature of the receiving tank immediately before the flash crystallization is preferably 0° C. to 50° C.

The flash crystallization may be carried out, for example, with the outlet of the connecting pipe extending from the dissolution tank being disposed in the atmosphere in the receiving tank, or disposed submerged in the poor solvent for the fluorine resin in the receiving tank. The outlet is preferably disposed submerged in the poor solvent, because it allows for obtaining finer fluorine resin particles.

The fluorine resin particles produced in the above described precipitation step (step a1), particularly, in the (step a2), can be obtained as a dispersion liquid or a suspension liquid. When the dispersion liquid contains coarse particles such as the undissolved portion of the fluorine resin charged, they can be removed by filtration or the like.

The method according to one example allows for stable production of fine fluorine resin particles having a uniform particle size. The use of fluorine resin particles, particularly, the use of polyvinylidene fluoride resin particles composed of a copolymer of vinylidene fluoride and hexafluoropropylene improves the adhesive property without compromising its air permeability.

Examples of the phase separation method include a method in which the fluorine resin is dissolved in a solvent, and the resulting fluorine resin solution is emulsified using a non-solvent or the like, and brought into contact with a poor solvent, thereby forming fluorine resin particles.

Examples of the dry grinding method include a method in which the fluorine resin particles are allowed to collide with each other, thereby grinding the particles, and a method in which the particles are allowed to collide into a metal wall, thereby grinding the particles.

Examples of the wet grinding method include a method in which beads of zirconia or the like are added to a dispersion medium in which the fluorine resin particles are dispersed, and the resultant is stirred to allow the beads to collide with the fluorine resin particles, thereby grinding the particles. The material and the diameter of the beads may be selected depending on the shape and the size of the fluorine resin particles of interest.

Examples of the spray dryer method include a method in which the fluorine resin is dissolved in a solvent, and the resulting resin solution is ejected through a nozzle to form droplets, followed by drying the droplets, thereby forming fluorine resin particles. The solvent to be used in the spray dryer method is not particularly limited as long as it is capable of dissolving the fluorine resin. However, a solvent having a boiling point lower than the melting point of the fluorine resin is preferred. Specific examples thereof include acetone, methyl ethyl ketone, methyl isobutyl ketone, methanol, ethanol, 1-propanol, 2-propanol, 1-butanol, ethyl acetate, propyl acetate, butyl acetate, tetrahydrofuran, cyclohexanone and the like.

Inorganic particles

The above described porous layer preferably includes inorganic particles to improve the dimensional stability of the secondary battery separator. The secondary battery separator preferably has a heat shrinkage at 130° C. for 1 hour of not more than 10%, as the required dimensional stability. The inorganic particles are required, for example, to be electrically stable within a battery, to have an electrical insulating property, and to have heat resistance.

Specific examples of the inorganic particles include particles of inorganic oxides such as aluminum oxide, boehmite, silica, titanium oxide, zirconium oxide, iron oxide, and magnesium oxide; particles of inorganic nitrides such as aluminum nitride, and silicon nitride; poorly soluble ion crystal particles such as particles of calcium fluoride, barium fluoride, and barium sulfate; and the like. These particles may be used singly, or two or more of these may be used as a mixture.

The inorganic particles to be used have an average particle size of 0.10 μm or more and 5.0 μm or less. The average particle size is preferably 0.20 μm or more and 3.0 μm or less, and more preferably 0.30 μm or more and 1.0 μm or less. An average particle size of less than 0.10 μm may result in a dense porous layer, possibly leading to an increased air permeability. Further, since the diameter of the pores in the porous layer is decreased, the ability of the porous layer to be impregnated with the electrolyte solution may be decreased, potentially having an impact on the productivity. An average particle size of greater than 5.0 μm, on the other hand, may result in a failure to provide sufficient dimensional stability, and in an increased thickness of the porous layer, possibly reducing the battery performance.

In addition, the inorganic particles preferably have an average particle size of not less than 0.2 times and not more than 100 times the average particle size of the fluorine resin particles. The average particle size is more preferably not less than 0.5 times and not more than 50 times, and still more preferably not less than 1.0 times and not more than 30 times the average particle size of the fluorine resin particles. An average particle size of less than 0.2 times may result in a failure to provide sufficient dimensional stability. An average particle size of greater than 100 times, on the other hand, may result in a failure to provide sufficient adhesive property to an electrode.

The inorganic particles to be used may have any shape, and may be in the shape of, for example, a sphere, a plate, a needle, a rod, an oval or the like. Of these, preferred are the inorganic particles in the shape of a sphere, in terms of surface modifiability, dispersibility, and coating performance.

### Organic Resin Binder

The porous layer may include an organic resin binder, if necessary, to bind the fluorine resin particles with one another, the inorganic particles with one another, or the fluorine resin particles with the inorganic particles, and to bind the fluorine resin particles and the inorganic particles to a porous substrate. Further, incorporation of an organic resin binder may serve to improve the adhesive property to an electrode.

Examples of organic resins to be used as the organic resin binder include fluorine resins, acrylic resins, styrene-butadiene resins, cross-linked polystyrenes, methyl methacrylate-styrene copolymers, polyimides, melamine resins, phenol resins, polyacrylonitriles, silicon resins, polycarbonates, carboxymethyl cellulose resins and the like. These resins may be used singly, or two or more may be used as a mixture. Among the above described binder resins, it is preferred to use a fluorine resin, an acrylic resin, a styrene-butadiene resin, and a carboxymethyl cellulose resin, and particularly preferably, a fluorine resin and an acrylic resin, in terms of electrical stability and oxidation resistance.

The form of the organic resin binder to be used is not particularly limited, and it is possible to use an organic resin binder soluble in a solvent, or an organic resin binder in the form of particles.

The organic resin binder in the form of particles may be one in which the entirety or a part thereof forms a film, or one which does not form a film, during the formation of the porous layer. To allow the organic resin binder in the form of particles to form a film, heat may be applied when drying a solvent, or a film forming auxiliary agent may be added such as N-methyl-2-pyrrolidone, dimethylacetamide, dipropylene glycol methyl ether, butyl glycol, propylene glycol, or 2,2,4-trimethyl-1,3-pentanediol monoisobutyrate.

The organic resin binder in the form of particles preferably has an average particle size of 1μm or less. When the organic resin binder has an average particle size of greater than 1 um, the battery performance may be reduced, because the amount of the organic resin binder required to bind the fluorine resin particles and the like is increased.

The content of the organic resin binder is preferably 1.0 part by mass or more and 100 parts by mass or less, more preferably 1.2 parts by mass or more, still more preferably 50 parts by mass or less, and still more preferably 30 parts by mass or less, with respect to 100 parts by mass of the total amount of the fluorine resin particles and the inorganic particles. When the content of the organic resin binder is greater than 100 parts by mass, the adhesive property of the porous layer may be decreased because the content of the fluorine resin particles is decreased to result in a reduced contact area between the electrode and the fluorine resin particles. In addition, it may result in a greater increase in air permeability, and thus, in a reduced battery performance. When the content of the organic resin binder is less than 1.0 part by mass, on the other hand, the binding ability of the binder is less likely to be demonstrated, and the fluorine resin particles and the inorganic particles laminated on a porous substrate may fall off, possibly complicating formation of a porous layer.

### Formation of Porous Layer

The secondary battery separator is obtained by a method of producing a secondary battery separator, the method including the step of laminating, on at least one surface of a porous substrate, a porous layer including fluorine resin particles and inorganic particles; wherein the fluorine resin particles are formed using a fluorine resin having a weight-average molecular weight of 100,000 or more and 5,000,000 or less, and have an average particle size of 0.01 μm or more and 1.00 μm or less; and wherein the inorganic particles have an average particle size of 0.10 μm or more and 5.0 μm or less. The method of producing a secondary battery separator will be described below.

The fluorine resin particles obtained by a known method such as emulsion polymerization, suspension polymerization or dispersion polymerization, or the fluorine resin particles which have been processed after polymerization to have a desired average particle size and shape, and the inorganic particles, are dispersed in a solvent to prepare a coating liquid. The solvent in which these particles are dispersed is preferably a solvent comprising water as a main component, in terms of preventing the porous substrate from being impregnated with the solvent. Note that the phrase “comprising as a main component” as used above means that water is included in an amount of 50% by mass or more, in 100% by mass of the amount of the solvent.

The proportion of water in the solvent comprising water as a main component is preferably 50% by mass or more, more preferably 60% by mass or more, and still more preferably 70% by mass or more. If the proportion of water in the solvent is less than 50% by mass, the resulting coating liquid may be impregnated into the porous substrate when being coated thereon, possibly resulting in a failure to form a desired porous layer. Further, the impregnation of the coating liquid into the porous substrate may complicate the transportation thereof, possibly resulting in an occurrence of creases during the transportation.

A dispersant may be used, if necessary, when the fluorine resin particles and the inorganic particles are dispersed in a solvent. The type of the dispersant is not particularly limited. Examples thereof include: cationic surfactants such as alkylamine salts, and quaternary ammonium salts; anionic surfactants such as alkyl sulfuric acid ester salts, polyoxyethylene alkyl ether sulfuric acid ester salts, alkyl benzene sulfonic acid salts, and fatty acid salts; nonionic surface active agents such as polyoxyethylene alkyl ethers, polyoxyethylene alkyl phenols, glycerin fatty acid esters, and polyoxyethylene fatty acid esters; amphoteric surfactants such as alkyl betaines, and alkyl amine oxides; and cationic, anionic, nonionic and amphoteric fluorochemical surfactants; silicon surfactants; and the like. Other examples of the dispersant include high molecular weight compounds such as polyvinyl pyrrolidones, polycarboxylic acid salts, polysulfonic acid salts, polyethers and the like. These dispersants may be used singly, or two or more may be used as a mixture.

The amount of the dispersant to be added is preferably 0.1 parts by mass or more and 40 parts by mass or less, more preferably 0.2 parts by mass or more, and still more preferably 0.5 parts by mass or more, with respect to 100 parts by mass of the total amount of the fluorine resin particles and the inorganic particles to be dispersed. Further, the added amount of the dispersant is preferably 30 parts by mass or less, and more preferably 20 parts by mass or less. When the added amount of the dispersant is greater than 40 parts by mass, the content of the fluorine resin particles in the porous layer is relatively decreased, and thus, the adhesive property of the porous layer may be decreased.

The fluorine resin particles and the inorganic particles can be dispersed using a known technique. Examples of mixing dispersers which can be used for dispersing the particles include a ball mill, a bead mill, a sand mill, a roll mill, a homogenizer, an ultrasonic homogenizer, a high-pressure homogenizer, an ultrasonic device, a paint shaker and the like. The particles may be dispersed in stages by using a plurality of these mixing dispersers in combination.

The order of the steps for preparing the coating liquid is not particularly limited. In terms of efficiency improvement in the step of dispersing the particles, it is preferred that the dispersant be added to the solvent comprising water as a main component, followed by mixing, and then the fluorine resin particles and the inorganic particles be added to the resulting solution, thereby preparing a coating liquid.

The coating liquid may include the above mentioned organic resin binder, if necessary, to bind the particles with one another, or to bind the particles to a porous substrate. Further, the coating liquid may include, if necessary, an antioxidant, a stabilizer, an antifoaming agent, a leveling agent and/or the like, as appropriate.

The type of the leveling agent is not particularly limited. Examples thereof include: cationic surfactants such as alkylamine salts, and quaternary ammonium salts; anionic surfactants such as alkyl sulfuric acid ester salts, polyoxyethylene alkyl ether sulfuric acid ester salts, alkyl benzene sulfonic acid salts, and fatty acid salts; nonionic surface active agents such as polyoxyethylene alkyl ethers, polyoxyethylene alkyl phenols, glycerin fatty acid esters, and polyoxyethylene fatty acid esters; amphoteric surfactants such as alkyl betaines, and alkyl amine oxides; and cationic, anionic, nonionic and amphoteric fluorochemical surfactants; silicon surfactants; high molecular weight compounds such as polyvinyl pyrrolidones, polycarboxylic acid salts, polysulfonic acid salts, and polyethers; and the like.

The amount of the leveling agent to be added is preferably 20 parts by mass or less, more preferably 10 parts by mass or less, and still more preferably 5 parts by mass or less, with respect to 100 parts by mass the total amount of the fluorine resin particles and the inorganic particles. When the added amount of the leveling agent is greater than 20 parts by mass, it may result in a decrease in the adhesive property, as well as in a decrease in the battery performance due to side reactions in the secondary battery.

Next, the thus obtained coating liquid is coated on a porous substrate, followed by drying, thereby laminating a porous layer on the porous substrate. The coating may be carried out by a known coating method. Examples of the coating method which can be used include methods such as gravure coating, slit die coating, knife coating, kiss coating, roll coating, bar coating, air spray coating, immersion coating, spin coating, screen printing, ink-jet printing, and pat printing, other types of printing methods and the like. The coating method is not limited to those described above, and it may be selected as appropriate to suit the conditions preferred for the fluorine resin particles, the inorganic particles, the binder, the dispersant, the leveling agent, the solvent, the substrate and the like, to be used. To improve the coating performance, the coating surface of the porous substrate may be subjected, for example, to a surface treatment such as a corona treatment or a plasma treatment.

When the porous layer is laminated on both surfaces of the porous substrate, one of the surfaces may be coated and dried first, and then the other. However, it is preferred that the coating and drying be carried out simultaneously on both surfaces since it is more efficient in terms of productivity.

Further, it is preferred that the porous layer be laminated on both surfaces, rather than only on one surface, of the porous substrate, because it allows for providing an adhesive property to both positive and negative electrodes, thereby improving the cycle performance. In addition, it is preferred that each of the porous layers laminated on both surfaces of the porous substrate be a porous layer including fluorine resin particles and inorganic particles; wherein the fluorine resin particles are formed using our fluorine resin having a weight-average molecular weight of 100,000 or more and 5,000,000 or less, and have an average particle size of 0.01 μm or more and 1.00 μm or less; and wherein the inorganic particles have an average particle size of 0.10 μm or more and 5.0 μm or less. Further, it is preferred that both the porous layers be identical since it is more efficient in terms of productivity, as described above, and the adhesive property to the positive electrode and that to the negative electrode can be obtained in equal strength.

The proportion of the fluorine resin particles in the porous layer is preferably 10% by mass or more and 90% by mass or less, more preferably 15% by mass or more and 80% by mass or less, with respect to 100% by mass of the total amount of the porous layer. The proportion of the fluorine resin particles is more preferably 20% by mass or more, and still more preferably 60% by mass or less. When the proportion of the fluorine resin particles in the porous layer is less than 10% by mass, a sufficient adhesive property may not be obtained. When the proportion of the fluorine resin particles is greater than 90% by mass, on the other hand, the content of the inorganic particles is relatively reduced, possibly resulting in a failure to provide sufficient dimensional stability.

The porous layer may include resin particles other than the fluorine resin particles. Examples of the resin particles other than the fluorine resin particles include resin particles formed using resins other than fluorine resins, and fluorine resin particles formed using fluorine resins having a weight-average molecular weight of less than 100,000.

The porous layer preferably has a thickness of 0.10 μm or more and 5.0 μm or less. The thickness is more preferably 0.3 μm or more and 4.0 μm or less. The thickness is still more preferably 0.5 μm or more and 3.0 μm or less. When the porous layer has a thickness of less than 0.10 μm, a sufficient adhesive property to an electrode may not be obtained. When the porous layer has a thickness of greater than 5.0 μm, on the other hand, it may result in a greater increase in air permeability, or in an insufficient adhesive property. Further, it is preferred that the porous layer be laminated on both surfaces of the porous substrate, because the lamination of the porous layer only on one surface may cause the resulting secondary battery separator to be significantly curled. When the porous layer is laminated on both surfaces of the porous substrate, for the above described reason, it is preferred that the difference in the thickness between the porous layers laminated on respective surfaces be 1 μm or less.

It is preferred that the increase in air permeability due to lamination of the porous layer(s) is not more than 5 times the original air permeability of the porous substrate before the lamination. The increase in air permeability is more preferably not more than 3 times the original air permeability. When the air permeability is increased to exceed 5 times the original air permeability due to lamination of the porous layer(s), the air permeability of the secondary battery separator as a whole may also be increased, possibly resulting in an insufficient ion migration, and thus, in a reduced battery performance.

### Porous Substrate

The porous substrate may be, for example, a porous membrane including internal pores, a nonwoven fabric, or a porous membrane sheet composed of a fibrous product. The porous substrate is preferably composed of a resin having an electrical insulating property, electrically stability, and stability in an electrolyte solution. The resin to be used is preferably a thermoplastic resin having a melting point of not more than 200° C., in terms of imparting a shutdown function to the resulting secondary battery separator. The shutdown function as used herein refers to a function of a secondary battery separator to stop the generation of power when a lithium ion battery is overheated, by melting due to heat to block the porous structure, and thereby inhibiting the migration of ions.

Examples of the thermoplastic resin include polyolefin resins, and the porous substrate is preferably a polyolefin porous substrate. Further, the polyolefin porous substrate is preferably a polyolefin porous substrate having a melting point of not more than 200° C. Specific examples of the polyolefin resin include polyethylenes, polypropylenes, copolymers thereof, and mixtures thereof. Examples of the polyolefin porous substrate include a monolayer porous substrate containing 90% by mass or more of polyethylene, and a multilayer porous substrate composed of polyethylene and polypropylene.

Examples of the method of producing the porous substrate include: a method in which a polyolefin resin is formed into a sheet, followed by stretching, thereby porosifying the resulting substrate; and a method in which a polyolefin resin dissolved in a solvent such as liquid paraffin is formed into a sheet, followed by extracting the solvent, thereby porosifying the substrate.

The porous substrate preferably has a thickness of 5 μm or more and 50 μm or less, and more preferably 5 μm or more and 30 μm or less. A porous substrate having a thickness of greater than 50 μm may have an increased internal resistance. A porous substrate having a thickness of less than 5 μm, on the other hand, may complicate the production of a secondary battery separator, and may fail to provide sufficient mechanical properties.

The porous substrate preferably has an air permeability of 50 sec/100 cc or more and 1,000 sec/100 cc or less. The porous substrate more preferably has an air permeability of 50/100 cc or more and 500 sec/100 cc or less. An air permeability of greater than 1,000 sec/100 cc may result in an insufficient ion migration, and thus, in a reduced battery performance. An air permeability of less than 50 sec/100 cc, on the other hand, may result in insufficient mechanical properties.

### Secondary Battery Separator

As described above, the secondary battery separator includes: a porous substrate; and a porous layer laminated on at least one surface of the porous substrate, wherein the porous layer includes the fluorine resin particles and the inorganic particles. It is preferred that the porous layer laminated on the porous substrate have a sufficiently high porosity to have an ion permeability. The secondary battery separator preferably has an air permeability of 50 sec/100 cc or more and 1,000 sec/100 cc or less. The secondary battery separator more preferably has an air permeability of 50 sec/100 cc or more and 500 sec/100 cc or less. An air permeability of greater than 1,000 sec/100 cc may result in an insufficient ion migration, and thus in a reduced battery performance. An air permeability of less than 50 sec/100 cc, on the other hand, may result in insufficient mechanical properties.

### Secondary Battery

The secondary battery separator can be suitably used in a secondary battery such as a lithium ion battery. The lithium ion battery has a structure including: a positive electrode including a positive electrode current collector and a positive active material laminated on the positive electrode current collector; a negative electrode including a negative electrode current collector and a negative active material laminated on the negative electrode current collector; and a secondary battery separator and an electrolyte interposed between the positive electrode and the negative electrode.

The positive electrode is obtained by laminating a positive electrode agent including an active material, a binder resin, and a conduction promoting agent, on a current collector. Examples of the active material include: lithium-containing transition metal oxides having a layered structure such as LiCoO₂, LiNiO₂, and Li(NiCoMn)O₂; spinel-type manganese oxides such as LiMn₂O₄; and iron compounds such as LiFePO₄; and the like. A resin having a high oxidation resistance can be used as the binder resin. Specific examples thereof include fluorine resins, acrylic resins, styrene-butadiene resins, and the like. A carbon material such as carbon black or graphite is used as the conduction promoting agent. A metal foil is suitably used as the current collector. In particular, an aluminum foil is often used.

The negative electrode is obtained by laminating a negative electrode agent including an active material and a binder resin on a current collector. Examples of the active material include: carbon materials such as artificial graphites, natural graphites, hard carbons, and soft carbons; lithium alloy materials with tin and silicon; metallic materials such as Li; lithium titanate (Li₄Ti₅O₁₂); and the like. A fluorine resin, an acrylic resin, a styrene-butadiene resin or the like is used as the binder resin. A metal foil is suitably used as the current collector. In particular, a copper foil is often used.

The electrolyte solution serves to allow migration of ions between the positive electrode and the negative electrode within the secondary battery, and is obtained by dissolving an electrolyte in an organic solvent. Examples of the electrolyte include LiPF₆, LiBF₄, LiClO₄, and the like. Of these, LiPF₆ is preferably used in terms of solubility in an organic solvent, and ion conductance. Examples of the organic solvent include ethylene carbonate, propylene carbonate, fluoroethylene carbonate, dimethyl carbonate, diethyl carbonate, ethyl methyl carbonate, γ-butyrolactone, sulfolane and the like. Two or more of these organic solvents may be used as a mixture.

To produce the secondary battery, first, an active material and a conduction promoting agent are dispersed in a binder solution to prepare an electrode coating liquid, for each of positive and negative electrodes. Each of the resulting coating liquids is coated on a current collector, followed by drying to remove the solvent, thereby obtaining a positive electrode and a negative electrode. It is preferred that each of the resulting coating films after drying has a thickness of 50 μm or more and 500 μm or less. Then the secondary battery separator is disposed between the thus obtained positive and negative electrodes to be in contact with the thus coated active material layers of the respective electrodes. The resultant is enclosed in an exterior material such as an aluminum laminate film, and an electrolyte solution is injected into the exterior material, followed by heat pressing. Subsequently, a negative electrode lead and a safety valve are disposed, followed by sealing the exterior material. The thus obtained secondary battery has an excellent cycle performance due to having a favorable adhesive property between the electrodes and the secondary battery separator, as well as excellent dimensional stability, and is capable of being produced at a low cost.

### EXAMPLES

Our separators, cells and methods will now be specifically described with reference to Examples. However, this disclosure is in no way limited by the Examples. Measurement methods used in the Examples will be shown below.

### Measurement Methods

(1) Average Particle Size

The surface of the porous layer was observed at a magnification of 50,000 times, using a field emission scanning electron microscope (S-3400N, manufactured by Hitachi Ltd.). The size of an image obtained by the observation is 2.5 μm×1.8 μm. The number of pixels in the image was 1,280 pixels x 960 pixels, and the size of one pixel was 2.0 nm×1.9 nm.

The average particle size was obtained as follows. A square or a rectangle which has a smallest area and which entirely surrounds one particle, namely, a square or a rectangle whose four sides are in contact with the edge of the particle, was drawn on the thus obtained image, and the length of one side in the case of the square, and the length of the long side (long axis diameter) in the case of the rectangle, was taken as the particle size. The particle size was measured for each of arbitrarily selected 100 particles, and the number average value of the measured particle sizes was taken as the average particle size. When 100 or more particles were observed in the captured image, the number average value of the measured particle sizes of the arbitrarily selected 100 particles was taken as the average particle size. When the number of particles observed in the image was less than 100, a plurality of images were captured, the particle size of a total of 100 particles in the images were measured, and the number average value of the measured particle sizes was taken as the average particle size.
(2) Weight-average Molecular Weight

The weight-average molecular weight of the fluorine resin was calculated in comparison with a calibration curve based on polystyrene, using a gel permeation chromatography method.

Apparatus: LC-10A series, manufactured by Shimadzu Corporation

Column: KD-806M x 2 columns, manufactured by SHOWA DENKO K.K.

Mobile phase: dimethylformamide

Flow rate: 1.0 ml/min

Detection: differential refractometer

Column temperature: 40° C.
(3) Thickness of Porous Layer

A cross sectional slice was cut out from a sample using a microtome, and the cross section was observed by a field emission scanning electron microscope (S-3400N, manufactured by Hitachi Ltd.). Within the thus observed region, the farthest point from the interface of the porous substrate and the porous layer was selected, and the distance between the farthest point and the interface was measured as the thickness of the porous layer. Five points in a sample having a size of 100 mm×100 mm were arbitrarily selected, the observation and the measurement were performed for each of the five points, and the average value of the measured values was calculated.
(4) Air Permeability

Three samples having a size of 100 mm×100 mm were prepared. One point in each of the samples was arbitrarily selected, and the measurement was performed at that point, using an air permeability measuring apparatus (EG01-5-1MR, manufactured by Asahi Seiko Co., Ltd.), in accordance with JIS P 8117 (2009). The average value of the measured values of the three samples was taken as the air permeability (sec/100 cc).
(5) Adhesion Strength

A solvent containing diethyl carbonate and ethylene carbonate in a mass ratio of 7:3 was prepared. Then the secondary battery separator film having a size of 15 mm×100 mm which was prepared in the Examples to be described later, and a positive electrode having a size of 15 mm×100 mm and including LiCoO₂ as the active material, a vinylidene fluoride resin as the binder, and carbon black as the conduction promoting agent, were immersed in the thus prepared solvent for 10 minutes. After retrieving from the solvent, the secondary battery separator film and the positive electrode were arranged such that the active material and the porous layer come into contact with each other. Heat pressing was then carried out using a heat pressing machine at 0.5 MPa and at 100° C. for 2 minutes. Thereafter, the secondary battery separator film was peeled off manually from the positive electrode using forceps, and the adhesion strength was evaluated and classified into the following four levels. In the same manner, the adhesion strength between the secondary battery separator and a negative electrode including graphite as the active material, a vinylidene fluoride resin as the binder, and carbon black as the conduction promoting agent, was measured. Then, the evaluation was performed for each of the positive electrode and the negative electrode, and the evaluation results were taken as the adhesion strength.
Adhesion strength S: The secondary battery separator was peeled off from the electrode with a strong force.
Adhesion strength A: The secondary battery separator was peeled off from the electrode with a relatively strong force.
Adhesion strength B: The secondary battery separator was peeled off from the electrode with a weak force.
Adhesion strength C: The secondary battery separator was peeled off from the electrode with a very weak force.
(6) Heat shrinkage rate (dimensional stability)

A sample having a size of 100 mm x 100 mm was prepared, and the distance between the midpoint of one side of the sample and the midpoint of the opposite side was measured. Then the sample was subjected to a heat treatment in an oven controlled at 130° C. for 1 hour, with no tension applied. The sample was taken out of the oven after the heat treatment, and the distance between the midpoints was measured at the same location as before the heat treatment. Then the heat shrinkage rate was calculated according to the following equation. The values of two locations in one sample were calculated at the same time, and the average value of the calculated values was taken as the heat shrinkage rate.
Heat shrinkage rate (%)=[(distance between midpoints before heat treatment−distance between midpoints after heat treatment)/(distance between midpoints before heat treatment)]×100.

### Example 1

A resin (a polyvinylidene fluoride resin, having a vinylidene fluoride content of 95 mol %, and containing a carboxylic acid group as an acid functional group) composed of a copolymer of vinylidene fluoride and hexafluoropropylene was dissolved in acetonitrile in an amount of 9,000 parts by mass with respect to 100 parts by mass of the copolymer, at 80° C. To the resulting solution, 11 parts by mass of water with respect to 100 parts by mass of acetonitrile was added, to prepare a polyvinylidene fluoride resin solution. The thus obtained polyvinylidene fluoride resin solution at 76° C. was continuously supplied into a tank (hereinafter, referred to as a “particle-forming tank”) containing water at normal temperature in an amount of 5,000 parts by mass with respect to 100 parts by mass of the copolymer, to obtain a particle-forming liquid.

Next, while simultaneously dropping a polyvinylidene fluoride resin solution (76° C.) which had been prepared separately, and 5,000 parts by mass water (normal temperature) with respect to 100 parts by mass of the copolymer into the particle-forming tank, each at a speed to complete the dropping in 6 minutes, the resulting particle-forming liquid (particle-forming liquid A) was extracted from the bottom portion of the particle-forming tank to maintain the liquid surface level of the particle-forming liquid. Subsequently, while simultaneously dropping a polyvinylidene fluoride resin solution (76° C.) which had been prepared separately, and 5,000 parts by mass water (normal temperature) with respect to 100 parts by mass of the copolymer into the particle-forming tank, each at a speed to complete the dropping in 6 minutes, the resulting particle-forming liquid (particle-forming liquid B) was extracted from the bottom portion of the particle-forming tank to maintain the liquid surface level of the particle-forming liquid.

The thus obtained particle-forming liquid A, the particle-forming liquid B, and a particle-forming liquid C remaining in the particle-forming tank, were combined, and acetonitrile was removed by distillation from the resulting mixture under reduced pressure. Then, the residue was subjected to centrifugal filtration. To 100 parts by mass of the thus obtained water-containing cake, 500 parts by mass of ion exchanged water was added to perform reslurry washing, followed by centrifugal filtration. To 100 parts by mass of the fluorine resin particles in the water-containing cake, 3 parts by mass of nonionic polyoxyethylene alkyl ether and 2 parts by mass of polyvinyl pyrrolidone as dispersants were added. Then 374 parts by mass of ion exchanged water was added to the resultant, followed by pre-dispersion using a homomixer. The thus obtained pre-dispersed liquid was treated with ultrasonic wave (output 120 W), and then subjected to centrifugal sedimentation to separate coarse particles, thereby obtaining a water dispersion liquid including fluorine resin particles having an average particle size of 0.10 μm. The weight-average molecular weight of the resulting fluorine resin particles was measured to be one million.

The thus obtained water dispersion liquid of fluorine resin particles, and a water dispersion liquid of aluminum oxide particles (average particle size: 0.50 μm) were mixed to a particle mass ratio of 3:7. Then an acrylic resin as a binder was added to the resultant in an amount of 10 parts by mass with respect to 100 parts by mass of the total amount of the fluorine resin particles and the aluminum oxide particles, to prepare a coating liquid. The resulting coating liquid was coated on both surfaces of a polyethylene porous substrate (thickness: 7 μm, air permeability: 110 sec/100 cc) by gravure coating. The resultant was dried until the solvent included in the coating was volatilized, to form a porous layer on each surface of the substrate, thereby obtaining a secondary battery separator. The proportion of the fluorine resin particles in the porous layer is 29% by mass. The measurements of the thickness, air permeability, adhesion strength, and heat shrinkage rate of the porous layer of the thus obtained secondary battery separator were carried out, and the results are shown in Tables 1 and 2. The measurements were performed in the same manner for the secondary battery separators of Examples and Comparative Examples to be described below, and the results are also shown in Tables 1 and 2.

### Example 2

The same procedure as in Example 1 was carried out except for using a polyvinylidene fluoride resin having a weight-average molecular weight of 800,000, to obtain a secondary battery separator.

### Example 3

The same procedure as in Example 1 was carried out except for using a polyvinylidene fluoride resin having a weight-average molecular weight of 600,000, and forming fluorine resin particles having an average particle size of 0.20 μm, to obtain a secondary battery separator.

### Example 4

The same procedure as in Example 1 was carried out except for changing the proportion of the fluorine resin particles in the porous layer to 48% by mass, to obtain a secondary battery separator.

### Example 5

The same procedure as in Example 1 was carried out except for using aluminum oxide particles having an average particle size of 1.30 μm, to obtain a secondary battery separator.

### Example 6

The same procedure as in Example 1 was carried out except for using a polyethylene porous substrate (thickness: 9 μm, air permeability: 150 sec/100 cc) as the porous substrate, to obtain a secondary battery separator.

### Example 7

The same procedure as in Example 1 was carried out except for changing the content of vinylidene fluoride to 70 mol %, to obtain a secondary battery separator.

### Example 8

The same procedure as in Example 1 was carried out except for using a polyvinylidene fluoride resin which includes no acid functional group, to obtain a secondary battery separator.

### Example 9

The same procedure as in Example 1 was carried out except for using, as a binder, a fluorine resin whose particles fuse with one another during drying in the formation of the porous layer, to obtain a secondary battery separator.

### Example 10

The same procedure as in Example 1 was carried out except for forming porous layers having a thickness of 1.1 μm, to obtain a secondary battery separator.

### Example 11

The same procedure as in Example 1 was carried out except for preparing fluorine resin particles having an average particle size of 0.30 μm, to obtain a secondary battery separator.

### Example 12

The same procedure as in Example 1 was carried out except for forming porous layers having a thickness of 2.0 μm, to obtain a secondary battery separator.

### Example 13

The same procedure as in Example 1 was carried out except for changing the proportion of the fluorine resin particles in the porous layer to 19% by mass, to obtain a secondary battery separator.

### Example 14

A resin (a polyvinylidene fluoride resin, having a vinylidene fluoride content of 95 mol %, and containing a carboxylic acid group as an acid functional group) composed of a copolymer of vinylidene fluoride and hexafluoropropylene was dissolved in acetonitrile in an amount of 9,000 parts by mass with respect to 100 parts by mass of the copolymer, at 80° C. To the resulting solution, 11 parts by mass of water with respect to 100 parts by mass of acetonitrile was added, to prepare a polyvinylidene fluoride resin solution. The thus obtained polyvinylidene fluoride resin solution at 76° C. was continuously supplied into a tank (hereinafter, referred to as a “particle-forming tank”) containing water at normal temperature in an amount of 5,000 parts by mass with respect to 100 parts by mass of the copolymer, to obtain a particle-forming liquid.

Next, while simultaneously dropping a polyvinylidene fluoride resin solution (76° C.) which had been prepared separately, and 5,000 parts by mass water (normal temperature) with respect to 100 parts by mass of the copolymer into the particle-forming tank, each at a speed to complete the dropping in 6 minutes, the resulting particle-forming liquid (particle-forming liquid A) was extracted from the bottom portion of the particle-forming tank to maintain the liquid surface level of the particle-forming liquid. Subsequently, while simultaneously dropping a polyvinylidene fluoride resin solution (76° C.) which had been prepared separately, and 5,000 parts by mass water (normal temperature) with respect to 100 parts by mass of the copolymer into the particle-forming tank, each at a speed to complete the dropping in 6 minutes, the resulting particle-forming liquid (particle-forming liquid B) was extracted from the bottom portion of the particle-forming tank to maintain the liquid surface level of the particle-forming liquid.

The thus obtained particle-forming liquid A, the particle-forming liquid B, and a particle-forming liquid C remaining in the particle-forming tank, were combined, and acetonitrile was removed by distillation from the resulting mixture under reduced pressure. Then, the residue was subjected to centrifugal filtration. To 100 parts by mass of the thus obtained water-containing cake, 500 parts by mass of ion exchanged water was added to perform reslurry washing, followed by centrifugal filtration. To 100 parts by mass of the fluorine resin particles in the water-containing cake, 4 parts by mass of polyvinyl pyrrolidone as a dispersant was added. Then 374 parts by mass of ion exchanged water was added to the resultant, followed by predispersion using a homomixer. The thus obtained pre-dispersed liquid was treated with ultrasonic wave (output 120 W), and then subjected to centrifugal sedimentation to separate coarse particles, thereby obtaining a water dispersion liquid including fluorine resin particles having an average particle size of 0.10 μm. The weight-average molecular weight of the resulting fluorine resin particles was measured to be one million.

The thus obtained water dispersion liquid of fluorine resin particles, and a water dispersion liquid of aluminum oxide particles (average particle size: 0.50 μm) were mixed to a particle mass ratio of 3:7. Then, to the resultant, an acrylic resin as a binder was added in an amount of 3.75 parts by mass with respect to 100 parts by mass of the total amount of the fluorine resin particles and the aluminum oxide particles, and a nonionic polyoxyethylene alkyl ether as a surfactant was added in an amount of 0.6 parts by mass with respect to 100 parts by mass of the total amount of the fluorine resin particles and the aluminum oxide particles, to prepare a coating liquid. The resulting coating liquid was coated on both surfaces of a polyethylene porous substrate (thickness: 9 μm, air permeability: 180 sec/100 cc) by gravure coating. The resultant was dried until the solvent included in the coating was volatilized, to form a porous layer on each surface of the substrate, thereby obtaining a secondary battery separator. The proportion of the fluorine resin particles in the porous layer is 28% by mass. The measurements of the thickness, air permeability, adhesion strength, and heat shrinkage rate of the porous layer of the thus obtained secondary battery separator were carried out, and the results are shown in Tables 1 and 2.

### Example 15

The same procedure as in Example 14 was carried out except for forming porous layers having a thickness of 2.0 μm, and using a polyethylene porous substrate having a thickness of 5 μm (air permeability: 110 sec/100 cc), to obtain a secondary battery separator.

### Example 16

The same procedure as in Example 14 was carried out except for using a polyvinylidene fluoride resin having a weight-average molecular weight of 2,200,000, to obtain a secondary battery separator.

### Example 17

The same procedure as in Example 16 was carried out except for forming porous layers having a thickness of 2.0 μm, and using a polyethylene porous substrate having a thickness of 5μm (air permeability: 110 sec/100 cc), to obtain a secondary battery separator.

### Example 18

The same procedure as in Example 16 was carried out except that: 0.6 parts by mass of a nonionic polyoxyethylene alkyl ether, and 2.0 parts by mass of a fatty acid polyether, as surfactants, were added with respect to 100 parts by mass of the total amount of the fluorine resin particles and the aluminum oxide particles; porous layers having a thickness of 1.5 μm were formed; and a polyethylene porous substrate having a thickness of 5 μm (air permeability: 110 sec /100 cc) was used, to obtain a secondary battery separator.

### Example 19

The same procedure as in Example 16 was carried out except that: 0.1 parts by mass of a perfluoroalkyl compound as a surfactant was added with respect to 100 parts by mass of the total amount of the fluorine resin particles and the aluminum oxide particles; porous layers having a thickness of 1.5 μm were formed; and a polyethylene porous substrate having a thickness of 5 μm (air permeability: 110 sec/100 cc) was used, to obtain a secondary battery separator.

### Example 20

The same procedure as in Example 16 was carried out except that: no surfactant was added; porous layers having a thickness of 1.5 μm were formed; and a polyethylene porous substrate having a thickness of 5μm (air permeability: 110 sec/100 cc) was used, to obtain a secondary battery separator.

### Comparative Example 1

The same procedure as in Example 1 was carried out except for using a polyvinylidene fluoride resin having a weight-average molecular weight of 80,000, and changing the content of vinylidene fluoride to 70 mol %, to obtain a secondary battery separator.

### Comparative Example 2

The same procedure as in Example 1 was carried out except for using aluminum oxide particles having an average particle size of 0.08 μm, and forming porous layers having a thickness of 1.0 μm, to obtain a secondary battery separator.

### Comparative Example 3

The same procedure as in Example 1 was carried out except that: a polyvinylidene fluoride resin having a weight-average molecular weight of 600,000 was used; fluorine resin particles having an average particle size of 2.00 μm were prepared; the content of vinylidene fluoride was changed to 70 mol %; and porous layers having a thickness of 1.6 μm were formed, to obtain a secondary battery separator.

### Comparative Example 4

The same procedure as in Example 1 was carried out except for using no inorganic particles, to obtain a secondary battery separator.

### Comparative Example 5

The same procedure as in Example 1 was carried out except for using a polyvinylidene fluoride resin having a weight-average molecular weight of 6,000,000, to obtain a secondary battery separator.

TABLE 1

| | | | | | | | Average | | | | |
|---|---|---|---|---|---|---|---|---|---|---|---|
| | | | | | | | particle | | | | |
| | | | | | | | size of | | | | |
| | | | | | | | inorganic | | | | |
| | | Average | | | | | particles/ | | | | |
| | Weight- | particle | | Presence | Fluorine | Average | Average | | | | |
| | average | size of | | or | resin | particle | particle | Thickness | | | |
| | molecular | fluorine | Vinylidene | absence | particles | size of | size of | of | Air | | Heat |
| | weight | resin | fluoride | of acid | ratio in | inorganic | fluorine | porous | Permeability | | shrinkage |
| | of fluorine | particles | content | functional | porous layer | particles | resin | layer | (sec/ | Adhesive | rate |
| | resin | (μm) | (mol %) | group | (% by mass) | (μm) | particles | (μm) | 100 cc) | strength | (%) |
| Example 1 | 1000000 | 0.10 | 95 | present | 29 | 0.50 | 5.00 | 1.3 | 145 | S | 5 |
| Example 2 | 800000 | 0.10 | 95 | present | 29 | 0.50 | 5.00 | 1.3 | 145 | A | 5 |
| Example 3 | 600000 | 0.20 | 95 | present | 29 | 0.50 | 2.50 | 1.4 | 140 | B | 6 |
| Example 4 | 1000000 | 0.10 | 95 | present | 48 | 0.50 | 5.00 | 1.2 | 150 | S | 7 |
| Example 5 | 1000000 | 0.10 | 95 | present | 29 | 1.30 | 13.00 | 1.6 | 170 | A | 8 |
| Example 6 | 1000000 | 0.10 | 95 | present | 29 | 0.50 | 5.00 | 1.3 | 180 | S | 5 |
| Example 7 | 1000000 | 0.10 | 70 | present | 29 | 0.50 | 5.00 | 1.3 | 180 | B | 5 |
| Example 8 | 1000000 | 0.10 | 95 | absent | 29 | 0.50 | 5.00 | 1.3 | 145 | B | 5 |
| Example 9 | 1000000 | 0.10 | 95 | present | 29 | 0.50 | 5.00 | 1.3 | 145 | S | 5 |
| Example 10 | 1000000 | 0.10 | 95 | present | 29 | 0.50 | 5.00 | 1.1 | 135 | A | 6 |
| Example 11 | 1000000 | 0.30 | 95 | present | 29 | 0.50 | 1.67 | 1.4 | 150 | A | 6 |
| Example 12 | 1000000 | 0.10 | 95 | present | 29 | 0.50 | 5.00 | 2.0 | 180 | S | 4 |
| Example 13 | 1000000 | 0.10 | 95 | present | 19 | 0.50 | 5.00 | 1.3 | 180 | A | 4 |

TABLE 2

| | | | | | | | Average | | | | |
|---|---|---|---|---|---|---|---|---|---|---|---|
| | | | | | | | particle | | | | |
| | | | | | | | size of | | | | |
| | | | | | | | inorganic | | | | |
| | | Average | | | | | particles/ | | | | |
| | Weight- | particle | | Presence | Fluorine | Average | Average | | | | |
| | average | size of | | or | resin | particle | particle | Thickness | | | |
| | molecular | fluorine | Vinylidene | absence | particles | size of | size of | of | Air | | Heat |
| | weight | resin | fluoride | of acid | ratio in | inorganic | fluorine | porous | Permeability | | shrinkage |
| | of fluorine | particles | content | functional | porous layer | particles | resin | layer | (sec/ | Adhesive | rate |
| | resin | (μm) | (mol %) | group | (% by mass) | (μm) | particles | (μm) | 100 cc) | strength | (%) |
| Example 14 | 1000000 | 0.10 | 95 | present | 28 | 0.50 | 5.00 | 1.4 | 200 | S | 5 |
| Example 15 | 1000000 | 0.10 | 95 | present | 28 | 0.50 | 5.00 | 2.0 | 160 | S | 3 |
| Example 16 | 2200000 | 0.10 | 95 | present | 28 | 0.50 | 5.00 | 1.4 | 200 | S | 5 |
| Example 17 | 2200000 | 0.10 | 95 | present | 28 | 0.50 | 5.00 | 2.0 | 160 | S | 3 |
| Example 18 | 2200000 | 0.10 | 95 | present | 28 | 0.50 | 5.00 | 1.5 | 160 | S | 4 |
| Example 19 | 2200000 | 0.10 | 95 | present | 28 | 0.50 | 5.00 | 1.5 | 140 | S | 4 |
| Example 20 | 2200000 | 0.10 | 95 | present | 28 | 0.50 | 5.00 | 1.5 | 130 | S | 4 |
| Comparative | 80000 | 0.10 | 70 | present | 29 | 0.50 | 5.00 | 1.3 | 150 | C | 6 |
| Example 1 | | | | | | | | | | | |
| Comparative | 1000000 | 0.10 | 95 | present | 29 | 0.08 | 0.80 | 1.0 | 200 | A | 14 |
| Example 2 | | | | | | | | | | | |
| Comparative | 600000 | 2.00 | 70 | present | 29 | 0.50 | 0.25 | 1.6 | 160 | C | 13 |
| Example 3 | | | | | | | | | | | |
| Comparative | 1000000 | 0.10 | 95 | present | 91 | — | — | 1.3 | 150 | S | 15 |
| Example 4 | | | | | | | | | | | |
| Comparative | 6000000 | 0.10 | 95 | present | 29 | 0.50 | 5.00 | 1.3 | 150 | C | 6 |
| Example 5 | | | | | | | | | | | |

It can be seen from the results shown in Tables 1 and 2 that our secondary battery separators of Examples 1 to 20 have a favorable adhesion strength to electrodes, and a low heat shrinkage (high dimensional stability). This is because the porous layers included in each of the secondary battery separators were formed using a fluorine resin having a weight-average molecular weight of 100,000 or more and 5,000,000 or less, and include fluorine resin particles having an average particle size of 0.01 μm or more and 1.00 μm or less, and inorganic particles having an average particle size of 0.10 μm or more and 5.0 μm or less.

On the other hand, the secondary battery separator of Comparative Example 1 does not have sufficient adhesion strength since the porous layers included therein were formed using a fluorine resin having a low weight-average molecular weight. The secondary battery separator of Comparative Example 2 does not have sufficient dimensional stability since the porous layers included therein have a high heat shrinkage rate due to containing inorganic particles having a small average particle size. The secondary battery separator of Comparative Example 3 does not have sufficient adhesion strength since the porous layers included therein contain fluorine resin particles having a large average particle size. Further, the porous layers have a high heat shrinkage rate, failing to provide sufficient dimensional stability. The secondary battery separator of Comparative Example 4 does not have sufficient dimensional stability since the porous layers included therein has a high heat shrinkage rate due to containing no inorganic particles. The secondary battery separator of Comparative Example 5 does not have sufficient adhesion strength since the porous layers included therein were formed using a fluorine resin having a high weight-average molecular weight.

1-13. (canceled)

14. A secondary battery separator comprising:
a porous substrate; and
a porous layer comprising fluorine resin particles and inorganic particles laminated on at least one surface of the porous substrate,
wherein the fluorine resin particles are formed using a fluorine resin having a weight-average molecular weight of 100,000 or more and 5,000,000 or less, and have an average particle size of 0.01 μm or more and 1.00 μm or less; and
the inorganic particles have an average particle size of 0.10 μm or more and 5.0 μm or less.

15. A secondary battery separator comprising:
a porous substrate; and
a porous layer comprising fluorine resin particles and inorganic particles laminated on at least one surface of the porous substrate,
wherein the fluorine resin particles are formed using a fluorine resin having a weight-average molecular weight of 600,000 or more and 1,500,000 or less, and have an average particle size of 0.02 μm or more and 0.40 μm or less; and
the inorganic particles have an average particle size of 0.10 μm or more and 5.0 μm or less.

16. The secondary battery separator according to claim 14, wherein the inorganic particles have an average particle size of not less than 0.2 times and not more than 100 times the average particle size of the fluorine resin particles.

17. The secondary battery separator according to claim 14, wherein the fluorine resin is a polyvinylidene fluoride resin, and the polyvinylidene fluoride resin has a vinylidene fluoride content of 80 mol % or more and less than 100 mol %.

18. The secondary battery separator according to claim 14, wherein the fluorine resin includes an acid functional group.

19. The secondary battery separator according to claim 18, wherein the acid functional group is a carboxylic acid group.

20. The secondary battery separator according to claim 14, wherein the fluorine resin particles are included in the porous layer in a proportion of 10% by mass or more and 90% by mass or less with respect to 100% by mass of the total amount of the porous layer.

21. The secondary battery separator according to claim 14, wherein the porous layer per one surface has a thickness 0.1 μm or more 5.0 μm or less.

22. The secondary battery separator according to claim 14, wherein the porous substrate is a polyolefin porous substrate.

23. The secondary battery separator according to claim 14, wherein the porous layer comprises an organic resin binder in an amount of 1.0 part by mass or more and 100 parts by mass or less with respect to 100 parts by mass of the total amount of the fluorine resin particles and the inorganic particles.

24. A method of producing a secondary battery separator comprising:
dispersing fluorine resin particles and inorganic particles in a solvent comprising water as a main component to obtain a dispersion liquid, wherein the fluorine resin particles are formed using a fluorine resin having a weight-average molecular weight of 100,000 or more and 5,000,000 or less, and have an average particle size of 0.01 μm or more and 1.00 μm or less; and
wherein the inorganic particles have an average particle size of 0.10 μm or more and 5.0 μm or less;
coating the resulting dispersion liquid on at least one surface of a porous substrate; and
drying the resultant to laminate a porous layer comprising the fluorine resin particles and the inorganic particles on the porous substrate.

25. The method according to claim 24,
wherein the fluorine resin particles are obtained by adding a fluorine resin solution prepared by dissolving a fluorine resin in a solvent and water to a poor solvent, to allow precipitation of the fluorine resin particles,
the amount of water is 1% by mass or more and 25% by mass or less with respect to 100% by mass of the total amount of the solvent and water, and
the amount of the fluorine resin is 0.1% by mass or more and 15% by mass or less with respect to 100% by mass of the total amount of the solvent and water.

26. A secondary battery comprising the secondary battery separator according to claim 14, or a secondary battery separator obtained by a method of producing a secondary battery separator comprising:
dispersing fluorine resin particles and inorganic particles in a solvent comprising water as a main component to obtain a dispersion liquid, wherein the fluorine resin particles are formed using a fluorine resin having a weight-average molecular weight of 100,000 or more and 5,000,000 or less, and have an average particle size of 0.01 μm or more and 1.00 μm or less; and
wherein the inorganic particles have an average particle size of 0.10 μm or more and 5.0 μm or less;
coating the resulting dispersion liquid on at least one surface of a porous substrate; and
drying the resultant to laminate a porous layer comprising the fluorine resin particles and the inorganic particles on the porous substrate.

27. The secondary battery separator according to claim 15, wherein the inorganic particles have an average particle size of not less than 0.2 times and not more than 100 times the average particle size of the fluorine resin particles.

28. The secondary battery separator according to claim 15, wherein the fluorine resin is a polyvinylidene fluoride resin, and the polyvinylidene fluoride resin has a vinylidene fluoride content of 80 mol % or more and less than 100 mol %.

29. The secondary battery separator according to claim 15, wherein the fluorine resin includes an acid functional group.

30. The secondary battery separator according to claim 15, wherein the acid functional group is a carboxylic acid group.

31. The secondary battery separator according to claim 15, wherein the fluorine resin particles are included in the porous layer in a proportion of 10% by mass or more and 90% by mass or less with respect to 100% by mass of the total amount of the porous layer.

32. The secondary battery separator according to claim 15, wherein the porous layer per one surface has a thickness 0.1 μm or more 5.0 μm or less.

33. The secondary battery separator according to claim 15, wherein the porous substrate is a polyolefin porous substrate.
